(19) United States
(12) Patent Application Publication
(10) Pub. No.: US 2026/0052465 A1
(43) Pub. Date: Feb. 19, 2026

(54) DYNAMIC LATENCY CONTROL IN A WIRELESS NETWORK

(71) Applicant: Charter Communications Operating, LLC, St. Louis, MO (US)

(72) Inventors: Inmaculada Carrion Rodrigo, Valley Center, CA (US); Jeffrey T. Levins, Denver, CO (US); Paul L. Russell, JR., Lawrence, NJ (US)

(21) Appl. No.: 19/291,884

(22) Filed: Aug. 6, 2025

Related U.S. Application Data
(60) Provisional application No. 63/684,326, filed on Aug. 16, 2024.

(51) Int. Cl. H04W 52/02; H04W 28/02; H04W 76/10

(52) U.S. Cl. CPC H04W 52/0203; H04W 28/0221; H04W 76/10

(57) ABSTRACT

A communication management resource can be configured to dynamically provide latency adjustments associated with queuing and forwarding data packets to support reduction in energy consumption. For example, the communication management resource can be configured to establish a first wireless link between a wireless base station and a first communication device. Assume that the communication management resource receives a first notification to change data packet latency settings of queuing and forwarding data packets associated with the first mobile communication device, where the data packets are queued for conveyance over the first wireless link. In response to receiving the first notification and other notifications, the communication management resource dynamically adjusts the data packet latency settings associated queuing and forwarding of the data packets over the first wireless link.

### RELATED APPLICATION

This application claims the benefit of earlier filed U.S. Provisional Patent Application Ser. No. 63/684,326 entitled “DYNAMIC LATENCY CONTROL IN A WIRELESS NETWORK,” (Attorney Docket No. CHTR-2024-139P), filed on Aug. 16, 2024, the entire teachings of which are incorporated herein by this reference.

### BACKGROUND

LAS, or Low Latency, Low Loss, Scalable throughput, and Secure communication, is a conventional approach to managing Internet traffic and Quality of Service (QoS) to improve communication parameters such as performance, efficiency, and security. LAS can be used to reduce latency experienced by packets traveling across the Internet.

In general, LAS has been primarily developed to address some limitations and challenges associated with traditional networking protocols, particularly in real-time applications, such as online gaming, video conferencing, and augmented reality/virtual reality (AR/VR) applications. In other words, one goal of conventional LAS data packet marking and forwarding is to reduce the amount of time that respective data packets wait in a queue before they are transmitted to a corresponding destination.

There are a number of new services that are latency critical such as gaming, AR/VR, real-time video conferencing, vehicle to everything (V2X), teleoperated driving, etc. These services can indicate a need for guaranteed low latency using, for example, LAS mechanisms currently being developed in 3GPP standards and other standard bodies. However, LAS only offers a mechanism to mark IP packet for special treatment at the network nodes to ensure a special treatment for those packets that require low latency.

In general, so-called end-to-end latency is the summation of three different factors: propagation, interface, and queuing delay. L4S addresses the single biggest—and most often overlooked-source of latency and latency variation or jitter: queuing delay.

Conventional LAS uses an Explicit Congestion Notification (ECN) scheme at the IP layer that is similar to the original (or ‘Classic’) ECN approach. LAS uses ‘Scalable’ congestion control, which induces much more frequent control signals from the network, and it responds to them with much more fine-grained adjustments so that very low (typically sub-millisecond on average) and consistently low queuing delay becomes possible for LAS traffic without compromising link utilization. Thus, even capacity-seeking (TCP-like) traffic can have high bandwidth and very low delay at the same time, even during periods of high traffic load.

### BRIEF DESCRIPTION

This disclosure includes the observation that, in order to provide real LAS service to applications that are latency critical, a high bit rate together with the status of the congestion in the network may be considered in order to provide real end-to-end low latency for a respective application. Data packet latency may occur due to multiple applications having a higher data rate demand than what the network can provide at a particular moment (congestion). For this reason, using dynamic data packet latency adjustments as discussed herein helps to ensure that applications that otherwise might require low latency can be downgraded (e.g. temporarily to high latency settings) when the network is congested. Such a solution as discussed herein may be implemented to optimize use of LAS and networks in general by avoiding unnecessary data packet storage in the network.

Further, this disclosure includes a communication management resource. As discussed herein, the communication management resource can be configured to dynamically provide latency adjustments associated with forwarding of data packets. For example, the communication management resource as discussed herein can be configured to establish a first wireless link between a wireless base station (such as a first wireless station) and a first mobile communication device (such as a second wireless station). Assume that the communication management resource receives a first notification to change data packet latency settings of queuing data packets associated with the first mobile communication device, where the data packets are queued for conveyance over the first wireless link. In response to receiving the first notification, the communication management resource dynamically adjusts the data packet latency settings associated queuing of the data packets associated with the first mobile communication device for conveyance over the first wireless link.

In one example, adjustment of the data packet latency settings as discussed herein includes the communication management resource, prior to receiving the first notification, applying a first data packet latency setting to first data packets queued for delivery over the first wireless link to the first mobile communication device. Subsequent to receiving the first notification such as indicating assent (such as confirmation or acceptance of use) to a data packet latency setting, the communication management resource can be configured to apply a second data packet latency setting to second data packets queued for delivery over the first wireless link to the first mobile communication device to provide better use of the wireless network resources. A magnitude of the second data packet latency setting may be greater than a magnitude of the first data packet latency setting. Thus, data packet latency adjustments as discussed herein may include increase in a data packet latency associated with data packets destined for delivery to a first mobile communication device. The increase in the data packet latency settings such as providing higher latency corresponds to a condition in which data packets reside in a buffer longer before being transmitted to a target than a prior condition of implementing lower data packet latency settings for the first mobile communication device.

Additionally, dynamic adjustment of the data packet latency settings associated with the first mobile communication device may include the communication management resource, subsequent to receiving the first notification, receiving a second notification to change the data packet latency settings of queuing data packets for the first mobile communication device. In response to receiving the second notification, the communication management resource such as associated with the wireless base station or other suitable entity applies the first data packet latency setting to third data packets queued for delivery over the first wireless link to the first mobile communication device. Thus, data packet latency adjustments as discussed herein may further include decrease of a data packet latency associated with data packets destined for delivery to a first mobile communication device. The decrease in the data packet latency settings such as providing lower latency corresponds to a condition in which data packets reside in a buffer for a shorter amount of time before being transmitted to a target than a prior condition of implementing higher data packet latency settings for the first mobile communication device.

In accordance with further examples, the communication management resource receives the first notification (indicating to adjust latency settings) from the first mobile communication device in response to communicating a message from the wireless base station over the first wireless link to the first mobile communication device. The message communicated from the communication management resource or other suitable entity to the first mobile communication device can be configured to include a request to adjust the data packet latency settings. In a further example, the adjusted data packet latency settings are operative to reduce energy consumption.

Still further, the wireless base station as discussed herein can be configured to transmit the message to the first mobile communication device in response to detecting a need for implementation of lower data packet latency settings associated with a second communication device.

Note that the communication from the first mobile communication device or other suitable entity may indicate the trigger event associated with discontinuing application of the adjusted data packet latency settings applied to data packets associated with the first mobile communication device. For example, the first notification can be configured to indicate a time window or time duration in which to adjust the data packet latency settings of queuing data packets associated with the first mobile communication device. After expiration of the time window, the original data packet latency settings can be again applied to data packets destined for delivery to the first mobile communication device. Accordingly, data packet latency settings may be requested on an as needed basis and, in accordance with specified needs, may be the implemented in accordance with schedule information indicating a time window or time duration in which to apply different requested data packet latency settings.

Yet further examples as discussed herein include the wireless base station supporting wireless connectivity to multiple mobile communication devices including the first mobile communication device and a second mobile communication device. In such an instance, the communication management resource establishes a second wireless link between the wireless base station and the second mobile communication device. In response to receiving a second notification over the second wireless link indicating to change data packet latency settings associated with queuing of data packets for delivery over the second wireless link to the second mobile communication device, the communication management resource communicates a message from the wireless base station over the second wireless link to the first mobile communication device. The message can be configured to include an acknowledgment of the change in data packet latency settings associated with the second mobile communication device.

In still further examples, the first notification indicating acceptance of a change in latency settings may be received from the first mobile communication device over the first wireless link. The first notification may indicate a threshold latency value in which to control latency of subsequent data packets conveyed to the first mobile communication device. In such an instance, adjustment of the data packet latency settings associated with the first mobile communication device may include scheduling the data packets for delivery over the first wireless link to the first mobile communication device based on the threshold latency value.

In still further examples as discussed herein, the first notification received by the wireless base station corresponding communication management resource is generated by the first mobile communication device based on power consumption associated with the first mobile communication device. For example, the mobile communication device can be configured to monitor power consumption or an amount of power remaining in a battery powering the mobile communication device. During a condition in which the remaining power the battery of the mobile communication device falls below a threshold level, the mobile communication device can request adjusted data packet latency settings to reduce overall power consumption by the mobile communication device.

In further examples as discussed herein, the mobile communication device or wireless base station can be configured to track credit earned by the first mobile communication device accepting implementation of first data packet latency settings of queuing the data packets destined for delivery from the wireless base station to the first mobile communication device. The wireless base station or other suitable entity can be configured to implement the adjusted or second data packet latency settings of queuing the data packets destined for delivery to the first mobile communication device in response to detecting that the tracked credit is greater than a threshold level. The mobile communication device may request the wireless base station to use the adjusted data packet latency settings of queuing respective data packets destined for the mobile communication device in response to the need for lower data packet latency, where the mobile communication device is entitled to the temporary lower data packet latency settings based on the earned credit being greater than a threshold level. In other words, the first mobile communication device can be configured to earn credit during conditions in which the first mobile communication device accepts the higher data packet latency settings as an alternative to lower data packet latency settings. The amount of earned credit may be proportional to an amount of time that the first mobile communication device accepts and is provided the higher data packet latency settings by the wireless base station. As previously discussed, the first mobile communication device may request the lower data packet latency settings in response to a condition in which the power consumption or amount of remaining power in a battery powering the first mobile communication device falls below a threshold level. The implementation of the lower data packet latency settings enables the first mobile communication device to complete a respective communication session and reserve battery power.

Techniques as discussed herein are useful over conventional techniques. For example, one or more implementation of a communication management resource and corresponding operations as discussed herein provide better use of a respective wireless network to more efficiently convey data in a wireless network.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform operations summarized above and disclosed in detail below. One such example comprises a computer program product including a non-transitory computer-readable storage medium or, more generally, any computer readable storage hardware on which software instructions are encoded in stored for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes computer readable storage hardware having instructions stored thereon. The instructions, when executed by corresponding computer processor hardware, cause the computer processor hardware (such as one or more co-located or disparately processor devices or hardware) to: establish a first wireless link between a wireless base station and a first mobile communication device; receive a first notification to change data packet latency settings of queuing data packets associated with the first mobile communication device, the data packets queued for conveyance over the first wireless link; and in response to receiving the first notification, adjust the data packet latency settings associated queuing of the data packets associated with the first mobile communication device for conveyance over the first wireless link.

Note that the ordering of the steps above has been added for clarity sake. Further, note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of controlling conveyance of data packets in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment implementing data packet flow management and dynamic latency control as discussed herein.

FIG. 2A is an example diagram illustrating first data packet latency settings for multiple communication devices as discussed herein.

FIG. 2B is an example diagram illustrating second data packet latency settings for multiple communication devices as discussed herein.

FIG. 3 is an example timing diagram illustrating dynamic latency control applied to multiple data packets as discussed herein.

FIG. 4 is an example diagram illustrating implementation of first data packet latency settings for a first time duration as discussed herein.

FIG. 5 is an example diagram illustrating implementation of second data packet latency settings for a second time duration as discussed herein.

FIG. 6 is an example diagram illustrating implementation of first data packet latency settings for a third time duration as discussed herein.

FIG. 7 is an example diagram illustrating example computer hardware and software operable to execute operations as discussed herein.

FIG. 8 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

Techniques herein support advertisement and negotiation of “latency tolerance” by an end-user or enterprise network with one goal being reduced energy consumption associated with one or more components in the network. To this end, a communication management resource can be configured to dynamically provide latency adjustments associated with queuing and forwarding data packets in a network environment.

As a specific example, a communication management resource can be configured to establish a first wireless link between a wireless base station and a first communication device. Data packets associated with the first communication device are queued for conveyance over the first wireless link to the first mobile communication device. Assume that the communication management resource receives a first notification to change data packet latency settings of queuing and forwarding data packets associated with the first communication device. The first notification can be received from any suitable entity. In response to receiving the first notification, and potentially other notifications, the communication management resource dynamically adjusts the data packet latency settings associated queuing and forwarding of the data packets over the first wireless link from the wireless base station to the first mobile communication device. The dynamic adjustment of latency provides better use of available wireless resources.

An indication such as a command or message from the mobile communication device to the wireless base station may indicate that the user or corresponding communication device is willing to accept a temporary increase in latency for a period of time, a particular service/application or services, for a data flow or set of data flows, for one of the users' devices or a set of users devices, or in a particular area, until a (estimated) energy savings threshold is reached, etc.

In certain instances, an end user and corresponding mobile communication device may be rewarded (credits, charging aspects) by subscribing to a dynamic latency adjustment service that increases the latency of generated traffic up to an upper acceptable latency threshold for all applications or a certain number of applications associated with the mobile communication device. Note that the dynamic latency adjustment service may be implemented in accordance with a special wireless network subscription, real-time (offer/accept), etc.

In further examples as discussed herein, an upper acceptable latency threshold could be set per subscription, per application, per time of day with accumulative measurements, etc., with respect to the subscriber mobile communication device provided wireless service. The adjusted or upper acceptable latency threshold could be suggested/offered by the network based on current congestion measurements. In other words, when there is a condition where dynamically adjusting the data packet latency associated with one or more mobile communication devices is desirable because the wireless base station experiences congestion for lack of congestion, the wireless network and corresponding communication management resource can be configured to communicate a request message to the mobile communication device. The request may be for the first mobile communication device to accept higher latency of data packets conveyed from the network to the first mobile communication device. The first mobile communication device may request lower latency settings at any time after accrual of credit based on the previous acceptance of higher latency settings by the first mobile communication device The first mobile communication device may be entitled to the adjusted data packet latency settings (such as providing lower latency) based upon the user of the first mobile communication device earning credits for prior accepted use of higher latency settings. In other words, the user of the first mobile communication device may have earned credits for agreeing to a higher latency settings for a first duration of time. After reaching a threshold level associated with earning credits for accepting use of higher latency settings between the first wireless base station and the first mobile communication device, the first mobile communication device may be entitled to on-demand use of the lower latency settings. In other words, after earning a certain amount of credit and that earned amount of credit exceeds a threshold level for using the higher latency settings, the user of the mobile communication device may request temporary use of the lower latency settings. In one example, the first mobile communication device trades the earned credit for lower latency settings.

In a further example, the network and corresponding first wireless base station, upon detecting congestion in a certain area where the user is roaming, may contact the user with an offer to temporarily adjust corresponding data packet latency settings to a higher latency settings. The wireless station may initially implement a default data packet latency setting for that user (subscription based, prior agreement/service contract) when it roams to a specific area, during a specific time of day, etc. The first mobile communication device may accept the offer to use the higher latency settings in order to earn credit as previously discussed.

In accordance with further examples as discussed herein, the end-user or mobile communication device can be configured to indicate, at initial registration or later during an active registration/session, that the mobile communication device and corresponding user are willing or may be willing to accept changes in data packet latency settings associated with communications conveyed to/from the mobile communication device. During times when the first wireless base station experiences congestion, the first wireless base station may notify the first mobile communication device with an inquiry of whether the first mobile communication device is willing to accept at least temporary use of higher data packet latency settings. If the first mobile communication device agrees to the higher data packet latency settings, the first wireless base station is able to use its freed up wireless resources such as including corresponding queues to provide lower data packet latency to a second mobile communication device in communication with the first wireless base station. Thus, the previous low latency provided to the first mobile communication device can be provided to the second mobile communication device, where the first mobile communication device earns credit for accepting use of the higher latency settings.

Note that the dynamic latency adjustment techniques as discussed herein can be implemented in any direction of conveying data between the wireless base station and a mobile communication device. For example, the wireless base station and corresponding communication management resource can be configured to implement dynamic latency adjustments for data packets communicated over a respective wireless communication link from the wireless base station to the mobile communication device. In a reverse direction, the mobile communication device can be configured to implement dynamic latency adjustments for data packets communicated over a respective wireless communication link from the mobile communication device to wireless base station.

Techniques herein can be implemented in any suitable manner such as using any type of quality of wireless service signaling including 3GPP QoS (quality of service) signaling.

In accordance with further examples as discussed herein, via ATSSS (Access Traffic Steering, Switching and Splitting) and/or DS (Dual Steer) or other mechanisms (such as mechanisms to hand in and/or hand out or mechanisms that facilitate roaming, mobility and access selection between different networks), the mobile communication device can be handed off to a wireless network that consumes less resources (e.g., powered by green energy) or a wireless network that is less congested or that is more appropriate for implementing latency adjustment negotiation as discussed herein. Techniques herein are also applicable to fixed networks, such as to provide energy efficiency and/or latency improvements in general or those associated with implementation of LAS.

Note further that there may be instances where the user or enterprise customer communication device may be willing to reduce the latency configuration settings to an agreeable threshold (such as higher latency or lower latency on an as needed basis) to ensure a lower energy consumption impact on the system.

Examples of dynamically adjusted latency and corresponding negotiations are further discussed below.

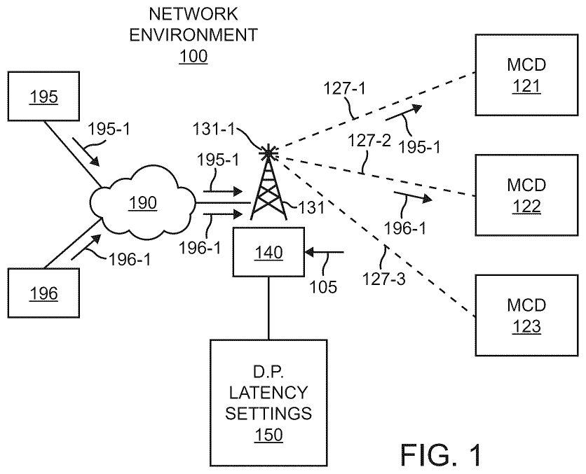

Now, more specifically, with reference to the drawings, FIG. 1 is an example diagram illustrating a network environment implementing data packet flow management and dynamic latency control as discussed herein.

As shown in FIG. 1, the network environment 100 includes server resource 195, server resource 196, network 190, wireless base station 131 (a.k.a., wireless access point) and corresponding communication management resource 140, mobile communication device 121, mobile communication device 122, mobile communication device 123, etc.

Note that the resources as discussed herein can be implemented via hardware, software, or a combination of hardware and software. For example, the communication management resource 140 can be implemented as communication management hardware, communication management software, or a combination of communication management hardware and communication management software; the mobile communication device 121 can be implemented as hardware, software, or a combination of hardware and software; the mobile communication device 122 can be implemented as hardware, software, or a combination of hardware and software; and so on.

Via respective communication links, the wireless base station 131 and corresponding communication management resource 140 provide the mobile communication devices access to the remote network 190 and corresponding communication devices such as server resource 195, server resource 196, etc.

Wireless base station 131 includes antenna hardware 131-1 (such as one or more antennas) to support wireless connectivity with each of the mobile communication devices in the network environment 100.

For example, the established wireless communication link 127-1 supports conveyance of wireless communications between the wireless base station 131 and the mobile communication device 121; the established wireless communication link 127-2 support conveyance of wireless communications between the wireless base station 131 and the mobile communication device 122; the established wireless communication link 127-3 supports conveyance of wireless communications between the wireless base station 131 and the mobile communication device 123; and so on.

Note that the wireless communication system as discussed herein including the wireless base station 131, mobile communication device 121, mobile communication device 122, mobile communication device 123, etc., can be implemented to support any suitable wireless communication protocols such as 4G, 5G, Wi-Fi™, DOCSIS (Data Over Cable Service Interface Specifications), IETF (Internet Engineering Task Force), etc. DOCSIS is a fixed network protocol. IETF protocols work for wireless and wired. Techniques as discussed herein can be implemented in satellite communications as well.

In further examples, the wireless communication system can be configured to implement any wireless communication protocol to support wireless communications between the wireless base station 131 and one or more mobile communication devices.

Yet further, the communication management resource 140 has access to stored data packet latency settings 150 (a.k.a., profile information) associated with each of the mobile communication devices (mobile communication device 121, mobile communication device 122, mobile communication device 123, etc.).

In one example, the techniques as discussed herein can be implemented via subscription based settings that are implemented per subscriber and not per device. Also, note that the system and techniques as discussed herein can be configured to include settings in a profile associated with each communication device. For a wireless network such as 3GPP case, techniques herein can be based on a subscription that the user has with the cellular operator.

As further discussed herein, the wireless base station 131 and corresponding communication management resource 140 can be configured to use the data packet latency settings 150 as a basis in which to dynamically control latency associated with queuing and/or forwarding of respective data packets to the different communication devices.

More specifically, the wireless base station 131 and the mobile communication device 121 establish wireless communication link 127-1 (such as a first wireless link) between the wireless base station 131 and the mobile communication device 121. The communication management resource 140 and corresponding wireless base station 131 can be configured to receive a notification 105 to change data packet latency settings of queuing data packets associated with the mobile communication device 121.

In one example, the notification 105 may be included in a respective wireless communication received from the mobile communication device 121. The notification 105 may indicate a data packet latency settings or threshold latency value to apply to wireless communications transmitted from the wireless base station 131 to the mobile communication device 121. In such an instance, wireless base station 131 adjusts the data packet latency settings applied to the mobile communication device 121, which may include scheduling the data packets for delivery over the wireless link to the first mobile communication device 121 based on a received threshold latency value.

In a further example, the data packets 195-1 (communications) are queued for conveyance over the wireless communication link 127-1 to the mobile communication device 121. In response to receiving the notification 105 (such as control communication), the communication management resource 140 adjusts data packet latency settings associated queuing of the data packets for conveyance of respective data packets over the wireless communication link 127-1 to the mobile communication device 121.

The wireless base station 131 and the mobile communication device 122 establish wireless communication link 1272 (such as a second wireless link) between the wireless base station 131 and the mobile communication device 122. The communication management resource 140 and corresponding wireless base station 131 can be configured to receive a notification (such as notification 105 or other control communication) to change data packet latency settings of queuing data packets associated with the mobile communication device 122.

In one example, the data packets 196-1 (communications) are queued for conveyance over the wireless communication link 127-2 to the mobile communication device 122. In response to receiving a notification, the communication management resource 140 adjusts data packet latency settings associated queuing of the data packets for conveyance of respective data packets over the wireless communication link 127-2 to the mobile communication device 122.

In a similar manner, data packet latency settings associated with any of the mobile communication devices in wireless communication with the wireless base station 131 can be dynamically adjusted to accommodate different network conditions.

It is noted that the mobile communication device 121 can be configured to implement a monitor function 121-1. The mobile communication device 121 can be configured to include the battery 121-2, which powers the mobile communication device 121. The monitor function 121-1 can be configured to monitor a parameter such as an amount of remaining battery power in a battery 121-2 of the mobile communication device 121, rate of power consumption associated with the mobile communication device 121, etc.

The mobile communication device 122 can be configured to implement a monitor function 122-1. The mobile communication device 122 can be configured to include the battery 122-2, which powers the mobile communication device 122. The monitor function 122-1 can be configured to monitor a parameter such as an amount of remaining battery power in a battery 122-2 of the mobile communication device 122, rate of power consumption associated with the mobile communication device 122, etc.

The mobile communication device 123 can be configured to implement a monitor function 123-1. The mobile communication device 123 can be configured to include the battery 123-2, which powers the mobile communication device 123. The monitor function 123-1 can be configured to monitor a parameter such as an amount of remaining battery power in a battery 123-2 of the mobile communication device 123, rate of power consumption associated with the mobile communication device 123, etc.

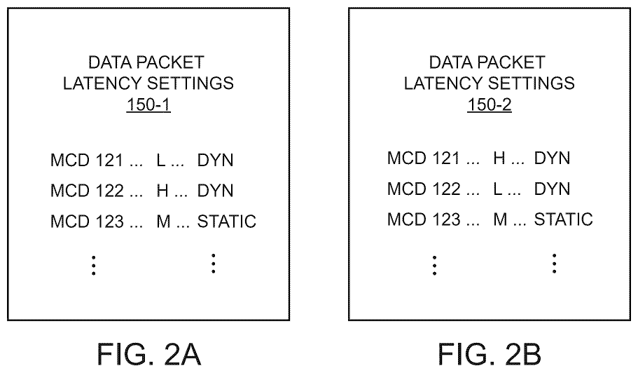

FIG. 2A is an example diagram illustrating first data packet latency settings for multiple communication devices as discussed herein.

In this example, the data packet latency settings 150-1 (first instance of the data packet latency settings 150 for a first time duration) indicate which of the multiple mobile communication devices support dynamic data packet latency adjustments as well as current data packet latency settings associated with each of the mobile communication devices.

The setting DYN in the data packet latency settings 150-1, 152, etc., indicates that the respective mobile communication device supports dynamic adjustment of respective data packet latency settings; the setting STATIC in the data packet latency settings indicates that the respective mobile communication device supports only an assigned non-changing for fixed data packet latency setting. The setting DYN supports negotiation of data packet latency settings as discussed herein.

For certain communication devices such as mobile communication device 121 and mobile communication device 122, the data packet latency settings 150 applied by the communication management resource 140 (at the wireless base station 131) to the received data packets for transmission to those communication devices as discussed herein change over time.

For example, the first instance of data packet latency settings 150-1 (such as implemented for time duration TD1) indicate that the mobile communication device 121 supports dynamic latency adjustments (see DYNAMIC assigned to the mobile communication device 121) and is currently (for time duration TD1) assigned a low level (L) latency setting associated with low latency queuing and forwarding from the wireless base station 131 to the mobile communication device 121; the data packet latency settings 150-1 indicate that the mobile communication device 122 supports dynamic latency adjustments (see DYNAMIC assigned to the mobile communication device 122) and is currently assigned a high level (H) latency setting associated with high latency queuing and forwarding; yet further, the data packet latency settings 150-1 indicate that the mobile communication device 123 supports only STATIC latency settings and is currently assigned a medium level (M) latency setting associated with medium latency queuing in forwarding; and so on.

As previously discussed, each of the different latency settings supports a different amount of latency of queuing and forwarding corresponding data packets. If desired, the different latency settings can be assigned to different applications executed on the respective mobile communication device. For example, as discussed herein, certain applications executed on a respective mobile communication device can be assigned dynamically latency settings over time.

More specifically, the low-level latency setting L can be configured to ensure that corresponding data packets destined for delivery from the wireless base station to the respective mobile communication device are forwarded from a respective queue to a target device in less than a latency threshold amount of time such as 1 millisecond (or other suitable threshold amount), where latency is measured based on a time of a data packet being stored in the respective queue in the communication management resource at the wireless base station 131; the medium latency setting M can be configured to ensure that corresponding data packets destined for delivery to the respective mobile communication device are forwarded from a respective queue in less than a latency threshold amount of time such as 20 milliseconds (other suitable threshold amount) from a time of initially being stored in the respective queue at the wireless base station 131; the high-level latency setting can be configured to ensure that corresponding data packets destined for delivery to the respective mobile communication device are forwarded from a respective queue in less than a latency threshold amount of time such as 50 milliseconds (or other suitable threshold amount) from a time of being stored within the respective queue at the wireless base station 131; and so on.

Again, note that the latency threshold times such as 1 millisecond, 25 milliseconds, 50 milliseconds, etc., are shown by way of example only and that these maximum latency threshold values may vary depending upon the application.

FIG. 2B is an example diagram illustrating second data packet latency settings for multiple communication devices as discussed herein.

In this example, in a similar manner as previously discussed, the data packet latency settings 150-2 (second instance of data packet latency settings 150 for a second time duration TD2) indicate which of the multiple mobile communication devices support dynamic data packet latency adjustments as well as current data packet latency settings associated with or assigned to each of the mobile communication devices.

For example, the data packet latency settings 150-2 (such as for time duration TD2) indicate that the mobile communication device 121 supports dynamic latency adjustments and is currently assigned a high level (H) latency setting; the data packet latency settings 150-2 indicate that the mobile communication device 122 supports dynamic latency adjustments and is currently assigned a low level (L) latency setting; the data packet latency settings 150-2 indicate that the mobile communication device 123 supports only static latency settings and is currently assigned a medium level (M) latency setting; and so on.

In a manner as previously discussed, each of the different latency settings can be configured to support a different amount of latency of queuing and forwarding corresponding data packets from the wireless base station 131 to the mobile communication devices 121, 122, etc.

For example, the low-level latency setting L (low latency setting) can be configured to ensure that corresponding data packets destined for delivery to the respective mobile communication device 122 are forwarded from a respective queue in less than 1 millisecond from a time of being stored in the respective queue; the medium latency setting M can be configured to ensure that corresponding data packets destined for delivery to the respective mobile communication device 123 are forwarded from a respective queue in less than 25 milliseconds from a time of being stored in the respective queue; the high-level latency setting H can be configured to ensure that corresponding data packets destined for delivery to the respective mobile communication device 121 are forwarded from a respective queue in less than 50 milliseconds from a time of being stored within the respective queue; and so on.

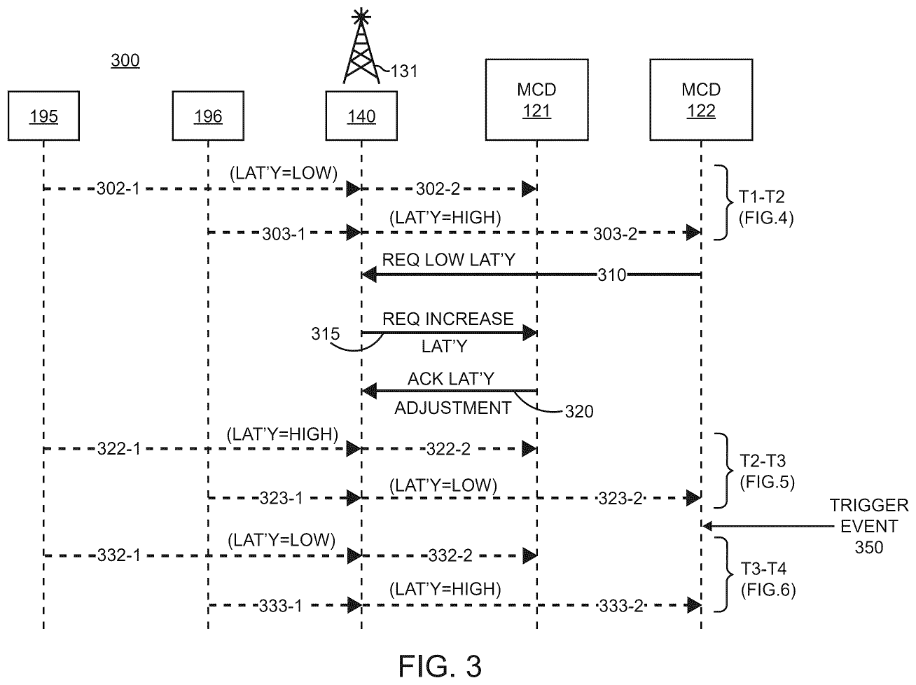

FIG. 3 is an example timing diagram illustrating dynamic latency control applied to multiple data packets as discussed herein.

As shown in communication flow timing diagram 300, during a first time duration such as between time T1 and time T2 (a.k.a., time duration TD1), the communication management resource 140 implements the data packet latency settings 150-1 to support communication of data packets 195-1 from the server 195 to the mobile communication device 121 as well as communication of data packets 196-1 from the server 196 to the mobile communication device 122.

More specifically, via communications 302-1, the server resource 195 or other suitable entity in the network environment 100 transmits data packets 195-1 through the network 190 to the mobile communication device 121 through the wireless base station 131 and corresponding communication management resource 140 over respective wireless in communication link 127-1. Because the mobile communication device 121 is assigned the low latency setting L as indicated by the currently implemented data packet latency settings 150-1 between time T1 and time T2, the communication management resource 140 forwards (wirelessly communicate) the corresponding data packets 195-1 via wireless communications 302-2 from the wireless base station 131 to the mobile communication device 121 such that the latency of storing the data packets 195-1 in a respective queues at wireless base station 131 and corresponding communication management resource 140 is less than a low latency threshold L (such as one millisecond).

Additionally, for the time duration between time T1 and time T2, via communications 303-1, the server resource 196 or other suitable entity transmits data packets 196-1 through the network 190 and wireless base station 131 and corresponding communication management resource 140 for delivery to the mobile communication device 122. Because the mobile communication device 122 is assigned the high latency setting H between time T1 and time T2, the communication management resource 140 forwards the corresponding data packets 196-1 via communications 303-2 such that the latency of storing the data packets 196-1 at wireless base station 131 and corresponding communication management resource 140 is up to of less than a high latency threshold H.

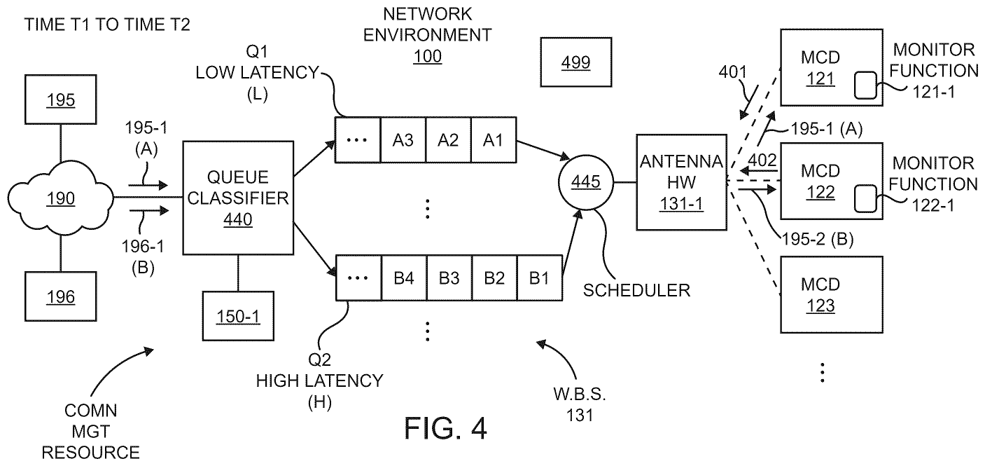

An example of such operations of controlling latency between time T1 and time T2 is shown in FIG. 4. FIG. 4 is discussed in further detail later in this specification.

Referring again to FIG. 3, at or around time T2, assume that the mobile communication device 122 transmits a request for a lower latency configuration setting to the communication management resource 140. The request for lower latency is generated by the mobile communication device 122 and as indicated by the communications 310 may occur as a result of any trigger event. As previously discussed, the mobile communication device 121 and corresponding user may be entitled to lower latency settings in response to prior higher data packet latency settings for greater than a threshold amount of time of communicating the communications 303-2 to the mobile communication device over the wireless communication link 127-2.

Note that the communication device 122 may temporarily require or desire low latency of conveying data packets (as indicated by the communication 310) for any suitable reason. In one example, the mobile communication device 122 transmits the communications 310 to the communication management resource 140. The communications 310 from the mobile communication device 122 may indicate a desire by the mobile communication device 122 and corresponding user for a lower latency setting of data packets conveyed through the wireless base station 131 over the wireless communication link 127-2 to the mobile communication device 122.

In one example, the mobile communication device 122 implements the monitor function 122-1 (see FIG. 1). The monitor function 122-1 can be configured to monitor a parameter such as an amount of remaining battery power in a battery 122-2 of the mobile communication device 122, rate of power consumption associated with the mobile communication device 122, etc. The mobile communication device 122 can be configured to request the change in its assigned latency settings in order to conserve energy associated with the battery 122-2. For example, the monitor function 122-1 implemented by the mobile communication device 122 can be configured to detect that amount of remaining battery power in a battery 122-2 of the mobile communication device falls below a threshold level. In such an instance, it is desirable to reduce the rate of energy consumption by the mobile communication device 122 consuming energy from the energy remaining in the battery 122-2. To this end, in response to detecting a trigger condition such as that the remaining battery power in the battery 122-2 falls below the threshold level, the mobile communication device 122 can be configured to transmit a respective notification to the wireless base station 131 corresponding communication management resource. The notification (such as communications 310) may include a request by the mobile communication device 122 and corresponding user for the wireless base station 131 to at least temporarily implement lower data packet latency settings (such as low latency settings L instead of high latency settings H) on behalf of the mobile communication device 122.

In a further example, note that the mobile communication device 122 can be configured to earn credits of requesting use of lower latency settings L in response to the mobile communication device 122 and corresponding user agreeing to the wireless base station 131 and corresponding communication management resource 140 implementing higher latency settings H of communicating data packets to the mobile communication device 122. For example, the wireless base station 131, mobile communication device 121, or other suitable entity, can be configured to produce credit information 499 (FIG. 4) indicating an amount of credit earned by the mobile communication device 122. The credit as indicated by the credit information 499 may increment based upon the amount of time that the mobile communication device 122 degrees to the implementation of the higher latency settings H. The mobile communication device 122 can be configured to redeem the earn credit as indicated by the credit information 499 to the provided the lower data latency settings L when the mobile communication device 122 and corresponding user wish to use/redeem the earned credit to be entitled to use of the lower latency settings. In other words, when the credit information 499 indicates that the mobile communication devices use the higher a latency settings H above a threshold amount of time enabling the communication device 122 to redeem those credits, the wireless base station 131 and corresponding components implement the lower latency settings as requested by the communications 310.

It is further noted that the mobile communication device 122 can be configured to provide notification to the wireless base station 131 and the communication management resource 140 regarding a specific timeframe in which the mobile communication device 122 like to implement low latency data packet settings instead of the high latency data packet settings. For example, the user of the mobile communication device 122 may indicate a desire to implement low latency settings L between a timeframe such as 8 o'clock to 9 o'clock p.m. on a particular day when the mobile communication device 122 needs low latency settings for whatever reason.

In response to any of the above or below mentioned trigger conditions or trigger events, the mobile communication device 122 can be configured to provide notification of the desire for low latency forwarding settings to the wireless base station 131 and corresponding communication management resource 140. As previously discussed, this may include transmitting communications 310 from the mobile communication device 122 to the wireless base station 131.

In further examples as discussed herein, the mobile communication device 122 or wireless base station 131 can be configured to track credit (such as indicated by credit 499 and FIG. 4) carried by the mobile communication device 122 accepting implementation of higher data packet latency settings H of queuing the data packets destined for delivery from the wireless base station 131 to the mobile communication device 122 such as during time T1 and time T2 or even prior to such a time duration. The wireless base station 131 or other suitable entity can be configured to implement the adjusted or lower data packet latency settings L of queuing the data packets destined for delivery to the mobile communication device 122 in response to detecting that the tracked credit associated with the mobile communication device 122 is greater than a threshold level. The mobile communication device 122 may request the wireless base station 131 to use the lower data packet latency settings of queuing respective data packets destined for the mobile communication device 122 in response to the need for lower data packet latency, where the mobile communication device 122 is entitled to the temporary lower data packet latency settings based on the earned credit (499) being greater than a threshold level. In other words, the mobile communication device 122 can be configured to earn credit during conditions in which the mobile communication device 122 accepts the higher data packet latency settings H as an alternative to lower data packet latency settings. The amount of earned credit may be proportional to an amount of time (such as between time T1 and time T2 as well as potentially prior to that time) that the mobile communication device 122 accepts and is provided the higher data packet latency settings H by the wireless base station 131. As previously discussed, the mobile communication device 122 may request the lower data packet latency settings L in response to a condition in which the power consumption or amount of remaining power in a battery powering the mobile communication device 122 falls below a threshold level. The implementation of the lower data packet latency settings L during the time duration T2 to time T3 enables the first mobile communication device to complete a respective communication session and reserve battery power. Thus, techniques herein include reducing overall power consumption in a network via implementation of novel data packet latency adjustment. In a further example, in response to receiving the request for lower latency or latency adjustment as indicated by communications 310 from the mobile communication device 122 to the wireless base station 131 in FIG. 3, or simply in response to detecting a condition such as congestion during which the ability to transmit data packets from the wireless base station 131 to any of the mobile communication devices is undesirably delayed, or for any other reason, the communication management resource 140 can be configured to transmit a message such as in communications 315 from the wireless base station 131 over the first wireless link 127-1 to the first mobile communication device 121. As mentioned, the message in the communications 315 may include a request for a change in latency settings applied to data packets communicated over the wireless communication link 127-1 to the mobile communication device 121. In other words, the mobile communication device 121 was previously assigned a low latency setting and is now request to accept and use a high latency setting. Thus, the communication management resource 140 can be configured to transmit the message in communications 315 to the first mobile communication device 121 in response to detecting a need for implementation of lower data packet latency settings associated with the second communication device 122 or other mobile communication devices. In other words, the low latency queues Q1 previously used to support communications from the wireless base station 131 to the mobile communication device 121 can be assigned for use by the wireless base station 131 to communicate subsequent wireless communications from the wireless base station 131 to the mobile communication device 122 instead of using those resources (Q1) to communicate with the mobile communication device 121. The wireless base station 131 can be configured to further communicate data packets from the wireless base station 131 to the mobile communication device 121 during the time duration between time T2 and time T3 in accordance with the higher latency settings using lower priority queues (Q2) with higher latency.

In one example, as previously discussed, the message in communications 315 can be configured to include a request to adjust the data packet latency settings assigned to the mobile communication device 121. The communication management resource 140 can be configured to communicate the request in response to detecting a need for use of the low latency queues Q1 and that mobile communication device 121 supports a dynamic data packet latency mode as indicated by the data packet latency settings 150-1. Further, as previously discussed, one reason to communicate the request to the mobile communication device 121 is to free up use of one or more low latency queues for forwarding data packets 196-1 to the mobile communication device 122, which made a prior request via communications 310 for a lower latency setting. However, the communication management resource 140 can be configured to transmit the request for adjusted latency settings to the mobile communication device 121 for any suitable reason.

As further shown in this example, via communications 320, the mobile communication device 121 provides notification (such as acknowledgment of the latency adjustment) that the adjustment of the data packet latency settings associated with the mobile communication device 121 from the low data packet latency setting L to the high data packet latency setting H or other level of data packet latency setting is acceptable to the user of the mobile communication device 121 or the mobile communication device 121 itself. If desired, in a reverse direction to the wireless base station 131, the mobile communication device 121 can be configured to specify a respective acceptable data packet latency setting such as the medium data packet latency setting M, or high data packet latency setting H. Thus, in certain instances, the mobile communication device 121 can be configured to select a higher latency setting when asked to switch to a higher latency setting.

In one example, the communications 320 communicated from the mobile communication device 121 to the communication management resource 140 is a response to the communications 315 and may include or trigger the notification 105 (FIG. 1) of changing data packet latency settings associated with the communication device 121 as previously discussed.

As a response to the acceptance (such as indicated by communications 320) of the higher latency settings by the mobile communication device 121, during a second time duration such as between time T2 and time T3, the communication management resource 140 implements the data packet latency settings 150-2 to support communication of subsequent data packets 195-1 from the server 195 to the mobile communication device 121 as well as subsequent communication of data packets 196-1 from the server 196 to the mobile communication device 122.

More specifically, via communications 322-1, and via the new data packet latency settings as specified by the data packet latency settings 150-2, the server resource 195 transmits data packets 195-1 to the wireless base station 131 and corresponding communication management resource 140. Because the mobile communication device 121 is now assigned the high latency setting H, the communication management resource 140 receives data packets via communications 322-1 and forwards the corresponding received data packets 195-1 via communications 322-2 such that the latency of storing the data packets 195-1 at wireless base station 131 and corresponding communication management resource 140 is less than a high latency threshold H.

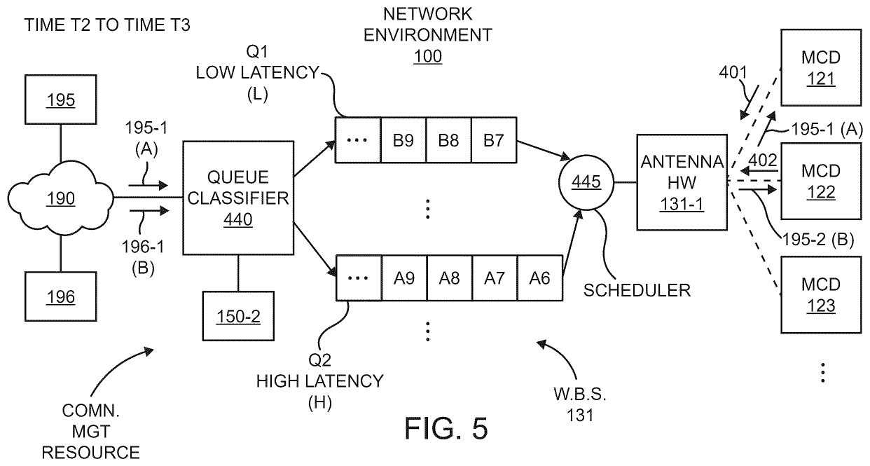

As further shown, and as previously discussed, the communication management resource 140 can be configured to provide lower latency settings to another mobile communication device because the mobile communication device 121 at least temporarily agreed (as indicated by communications 320) to the higher latency settings as indicated by the data packet latency settings 150-2. In such an instance, via communications 323-1, the server resource 196 transmits data packets 196-1 to the wireless base station 131 and corresponding communication management resource 140. Because the mobile communication device 122 is now assigned the low latency setting L, the communication management resource 140 forwards the corresponding data packets 196-1 (received in communications 323-1) via communications 323-2 from the wireless base station 131 to the mobile communication device 122 such that the latency of storing and forwarding the data packets 196-1 at wireless base station 131 and corresponding communication management resource 140 is less than a low latency threshold L. An example of such operations is shown in FIG. 5.

Thus, the dynamic adjustment of the data packet latency settings as discussed herein includes: prior to receiving a first notification to increase the latency associated with communications conveyed to/from the communication management resource 140 to the mobile communication device 121, the communication management resource 140 applies a first data packet latency setting L to first data packets 195-1 queued for delivery over the first wireless link 127-1 to the mobile communication device 121 between time T1 and time T2. Subsequent to receiving the first notification as indicated by communications 320 to support the higher latency level H, the communication management resource 140 applies a second data packet latency setting H to second data packets 195-1 queued for delivery over the first wireless link 127-1 to the mobile communication device 121 between time T2 and time T3. The adjustment to the data packet latency settings applied to data packets targeted for delivery to the mobile communication device 121 may be temporary. In this example, as previously discussed, a magnitude of the second data packet latency setting H is greater than a magnitude of the first data packet latency setting L.

In one example, the adjusted data packet latency settings are operative to reduce energy consumption associated with operation of the mobile communication devices and/or the wireless base station 131. For example, application of the low latency settings may not be necessary to support conveyance of the data packets 195-1. In other words, the data packets 195-1 communicated to the mobile communication device 121 between time T2 and time T3 may not need to be stored and forwarded in accordance with the low latency setting L. The lower latency settings provided to the mobile communication device 122 and the corresponding data packets 196-1 may result in the ability of mobile communication device 122 to be shut off (depowered) sooner, saving overall energy in power consumed by the mobile communication devices in the wireless communication system.

Additionally, it is noted that the high latency queue Q2 at the wireless base station 131 may consume more power than the low latency queue Q1, resulting in the wireless base station 131 consuming less power or energy as well. In one example, energy consumption by the wireless base station 131 or the mobile communication devices is proportional to a respective latency delay because more energy is expended to operate corresponding storage hardware and actual storage of respective data packets in queues of the wireless base station for longer durations of time.

In a further example, the notification in communications 320 or other communications from the mobile communication device 121 to the communication management resource 140 may indicate a temporary time window in which it is acceptable by the mobile communication device 121 for the wireless base station 131 and corresponding communication management resource 140 to adjust the data packet latency settings of queuing data packets associated with the first mobile communication device 121. After expiration of the time window, the communication management resource 140 can be configured to revert back from implementing data packet latency settings 150-2 to implementing data packet latency settings 150-1 again, because the data packet latency settings 150-1 may be a default for the mobile communication device 121 or other mobile communication devices.

More specifically, the communication management resource 140 can be configured to change the data packet latency settings associated with any of the mobile communication devices based on any trigger event 350 FIG. 3. For example, the trigger event such as around time T3 may be expiration of a time duration, notification request or command transmitted from the mobile communication device 121 for switch back from the high latency setting to the lower latency setting, etc. Trigger event 350 may also be any condition such as: determination that the mobile communication device 122 no longer needs to be assigned the low latency settings, the mobile communication device 121 needs to be provided the low latency settings again, scheduled time of providing the low latency settings to the mobile communication device 122 may expire, input from a respective user operating the mobile communication device 122 to implement the higher latency settings, etc.

In this example, subsequent to receiving the first notification (such as in communications 320) which was received at/or around time T2, the communication management resource 140 or other suitable entity receives a second notification (such as trigger event 350, which may be generated for any reason such as because the mobile communication device 121 transmits a respective wireless communication over the wireless communication link 127-1 to the communication management resource 140, the wireless communication indicating) to change the data packet latency settings of subsequent queuing of data packets 195-1 destined for delivery from the wireless base station 131 over the wireless communication link 127-1 to the mobile communication device 121 to the low latency setting L. In response to receiving the second notification such as based on the trigger event 350 indicating to switch implementation of different latency settings, the communication management resource 140 switches back to applying the data packet latency setting L to third data packets (data packets 195-1) queued for delivery over the first wireless link 127-1 between time T3 and time T4.

More specifically, between time T3 and time T4 as shown in communication flow timing diagram 300, during a third time duration such as between time T3 and time T4, the communication management resource 140 implements the data packet latency settings 150-1 again to support communication of data packets 195-1 from the server 195 to the mobile communication device 121 as well as communication of data packets 196-1 from the server 196 to the mobile communication device 122.

After the switch over to the configuration settings 150-1, via communications 332-1, the server resource 195 transmits data packets 195-1 to the mobile communication device 121 through the wireless base station 131 and corresponding communication management resource 140. Because the mobile communication device 121 is assigned the low latency setting L as indicated by the currently implemented data packet latency settings 150-1, the communication management resource 140 forwards the corresponding data packets 195-1 via communications 332-2 such that the latency of storing the data packets 195-1 at wireless base station 131 and corresponding communication management resource 140 is less than a low latency threshold L (such as one millisecond or other suitable amount).

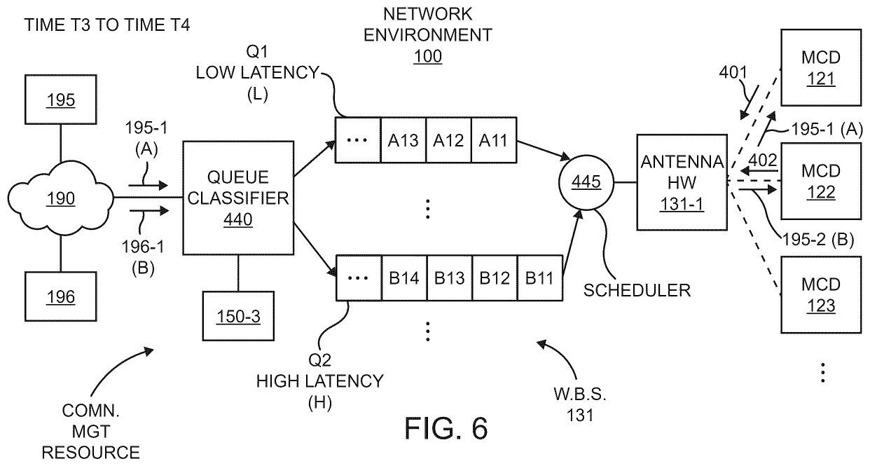

Additionally, for the time duration between time T3 and time T4, via communications 333-1, the server resource 196 transmits data packets 196-1 through the wireless base station 131 and corresponding communication management resource 140 for delivery to the mobile communication device 122. Because the mobile communication device 122 is assigned the high latency setting H again for the time duration between time T3 and time T4, the communication management resource 140 forwards the corresponding data packets 196-1 via communications 333-2 such that the latency of storing the data packets 196-1 at wireless base station 131 and corresponding communication management resource 140 is less than a high latency threshold H. An example of such operations between time T3 and time T4 is shown in FIG. 6.

FIG. 4 is an example diagram illustrating implementation of first data packet latency settings for a first time duration as discussed herein.

In this example, the communication management resource 140 in or associated with the wireless base station 131 includes queue classifier 440, low latency queue Q1, high latency queue Q2, . . . , and scheduler 445.

As previously discussed, between time T1 and time T2, the communication management resource 140 implements the data packet latency settings 150-1 (as shown in FIG. 2A).

Assume that the mobile communication device 121 transmits a respective communication 401 through the wireless base station 131 and network 190 to the server resource 195 for retrieval of content A. In response to receiving the request for content A from server resource 195, the server resource 195 transmits data packets 195-1 (stream of content such as labeled data packets Ax) over the network 190 through the wireless base station 131 to the mobile communication device 121.

In this example, the data packets 195-1 transmitted from the server resource 195 destined for delivery to the mobile communication device 121 include sequentially transmitted data packet such as data packet A1, data packet A2, data packet A3, etc.

The queue classifier 440 receives the data packet A1 destined for delivery to the mobile communication device 121. Based on a determination that the data packet A1 is destined for delivery to the mobile communication device 121 and via use of the data packet latency settings 150-1, in because the mobile communication device 121 is assigned the low latency queue Q1, the queue classifier 440 stores the received data packet A1 in the queue Q1 for subsequent delivery to the mobile communication device 121.

It is noted that the queue Q1 supports a low latency L in which each of the data packets stored in the queue Q1 are forwarded from the queue Q1 in less time than a low latency threshold time value assigned to the low latency setting L. In other words, each data packet stored in the queue Q1 is resident in the queue Q1 for less than the time value assigned to the low latency setting L.

In response to receiving the data packet A1, the queue classifier 440 determines from a destination value (such as a network address assigned to the mobile communication device 121) in the data packet A1 or other suitable entity that the data packet A1 is directed for delivery to the mobile communication device 121. Based on mapping the identity of the mobile communication device 121 as specified by the received data packet A1 to the low latency setting L as indicated by the data packet latency settings 150-1, the queue classifier 440 stores the received data packet A1 in the queue Q1. Eventually, in accordance with the low latency time assigned to the queue Q1, the wireless base station 131 wirelessly transmits respective data packet A1 to the mobile communication device 121.

In response to receiving the data packet A2, the queue classifier 440 determines from a destination value (such as network address assigned to the mobile communication device 121) in the data packet A2 or other suitable entity that the data packet A2 is directed to the mobile communication device 121. Based on mapping the identity of the mobile communication device 121 as specified by the received data packet A2 to the low latency setting L as indicated by the data packet latency settings 150-1, the queue classifier 440 stores the received data packet A2 in the queue Q1.

In a similar manner, between time T1 and time T2, the queue classifier 440 stores each of the received data packets 195-1 (A) in the queue Q1 and ensures that data packets destined for the mobile communication device 121 are stored in the low latency queue Q1.

As further shown, the scheduler 445 (associated with the communication management resource 140) manages transmissions of the received data packets in the queue Q1 over the antenna hardware 131-1 of the wireless base station 131 and the wireless communication link 127-1 for delivery to the mobile communication device 121. As previously discussed, the scheduler 445 ensures that each of the data packets A1, A2, A3, etc., stored in the queue Q1 are resident in the queue Q1 for less than or around a low latency well time value such as one millisecond or other suitable time value assigned to the low latency data packet setting L and corresponding queue Q1.

Further, as previously discussed, the mobile communication device 122 can be configured to request retrieval of content B from the server resource 196. In such an instance, the mobile communication device 122 transmits a respective request communication 402 through the wireless base station 131 and network 190 to the server resource 196 for retrieval of content B. In response to receiving the request, the server resource 196 transmits data packets 196-1 (stream of content such as labeled data packets Bx) over the network 190 through the wireless base station 131 to the mobile communication device 122.

In this example, the data packets 196-1 transmitted from the server resource 196 destined for delivery to the mobile communication device 122 includes sequentially transmitted data packet such as data packet B1, data packet B2, data packet B3, etc. The queue classifier 440 associated with the wireless base station 131 receives the data packet B1 destined for delivery to the mobile communication device 122. Based on a determination that the data packet B1 is destined for delivery to the mobile communication device 122 and use of the corresponding data packet latency settings 150-1, the queue classifier 440 stores the received data packet B1 in the queue Q2 for subsequent delivery to the mobile communication device 122.

It is noted that the queue Q2 supports a high latency H in which each of the data packets stored in the queue Q2 is forwarded from the queue Q2 in less time than a high latency threshold time value assigned to the high latency setting H. In other words, each data packet stored in the queue Q2 is resident in the high latency queue Q2 for around, up to, or less than the time value assigned to the high latency setting H.

In response to receiving the data packet B2, the queue classifier 440 determines from a destination value in the data packet B2 that the data packet B2 is directed to the mobile communication device 122. Based on mapping the identity of the mobile communication device 122 as specified by the received data packet B2 to the high latency setting H as indicated by the data packet latency settings 150-1, the queue classifier 440 stores the received data packet B2 in the queue Q2.

In response to receiving the data packet B3, the queue classifier 440 determines from a destination value in the data packet B3 that the data packet B3 is directed to the mobile communication device 122. Based on mapping the identity of the mobile communication device 122 as specified by the received data packet B3 to the high latency setting H as indicated by the data packet latency settings 150-1, the queue classifier 440 stores the received data packet B3 in the queue Q2.

In a similar manner, between time T1 and time T2, the queue classifier 440 stores each of the received data packets 196-1 (B) in the queue Q2.

As further shown, the scheduler 445 manages transmissions of the received data packets in the queue Q2 over the antenna hardware 131-1 of the wireless base station 131 and the wireless communication link 127-2 for delivery to the mobile communication device 122. As previously discussed, the scheduler 445 ensures that each of the data packets B1, B2, B3, etc., stored in the queue Q2 are resident in the queue Q2 for around or less than a high latency threshold value such as 50 milliseconds assigned to the high latency data packet setting H.

On average, the data packets stored in the low latency queue Q1 are resident in the low latency queue Q1 for less time than the respective data packets are stored in the high queue Q2 based on the scheduler 445 providing lower latency forwarding of communications (data packets) in the queue Q1. Thus, for certain time critical applications and/or communication devices, it may be desirable to store and forward data packets from the low latency queue Q1 instead of the high latency queue Q2. As previously discussed, trigger events may occur resulting in implementation of different latency settings for each of the different mobile communication devices.

FIG. 5 is an example diagram illustrating implementation of second data packet latency settings for a second time duration as discussed herein.

As previously discussed, between time T2 and time T3, the communication management resource 140 can be configured to implement the data packet latency settings 150-2 (as shown in FIG. 2B) in response to a trigger event such as the mobile communication device 121 at least temporarily agreeing to the higher latency setting H, and the mobile communication device 122 requiring lower latency setting L, etc.

In this example, the data packets 195-1 transmitted from the server resource 195 destined for delivery to the mobile communication device 122 includes sequentially transmitted data packet such as data packet A6, data packet A7, data packet A8, data packet A9, etc.

The queue classifier 440 receives the data packet A6 destined for delivery to the mobile communication device 121. Based on a determination that the data packet A6 is destined for delivery to the mobile communication device 121, and via use of the corresponding data packet latency settings 150-2, the queue classifier 440 stores the received data packet A6 in the queue Q2 for subsequent delivery to the mobile communication device 121.

It is again noted that the queue Q2 supports a high latency H in which each of the data packets stored in the queue Q2 is forwarded from the queue Q2 in around or less time than a high latency threshold time value assigned to the high latency setting H. In other words, each data packet stored in the queue Q2 is resident in the queue Q2 for around or less than the time value assigned to the high latency setting H.

As further shown, subsequent to receiving the data packet A6, the queue classifier 440 receives the data packet A7 destined for delivery to the mobile communication device 121. Based on a determination that the data packet A7 is destined for delivery to the mobile communication device 121 and use of the corresponding data packet latency settings 150-2, the queue classifier 440 stores the received data packet A7 in the queue Q2 for subsequent delivery to the mobile communication device 121.

In a similar manner, between time T2 and time T3, the queue classifier 440 stores each of the received data packets 195-1 (A) in the queue Q2.

As further shown, the scheduler 445 manages transmissions of the received data packets Ax (such as data packets A6, A7, A8, etc.) in the queue Q2 over the antenna hardware 131-1 of the wireless base station 131 and the wireless communication link 127-1 for delivery to the mobile communication device 121. As previously discussed, the scheduler 445 ensures that each of the data packets A6, A7, A8, etc., stored in the queue Q2 are resident in the queue Q2 for around or less than or no longer than a high latency value such as 50 milliseconds assigned to the high latency data packet setting H.

In response to receiving the request for content B, the server resource 196 transmits data packets 196-1 (stream of content such as labeled data packets Bx) over the network 190 through the wireless base station 131 to the mobile communication device 122.

In this example, the data packets 196-1 transmitted from the server resource 196 destined for delivery to the mobile communication device 122 include sequentially transmitted data packets such as data packet B7, data packet B8, data packet B9, etc.

The queue classifier 440 receives the data packet B7 destined for delivery to the mobile communication device 122. Based on a determination that the data packet B7 is destined for delivery to the mobile communication device 122 and via use of the data packet latency settings 150-2, the queue classifier 440 stores the received data packet B7 in the queue Q1 for subsequent delivery to the mobile communication device 122.

The queue classifier 440 receives the data packet B8 destined for delivery to the mobile communication device 122. Based on a determination that the data packet B8 is destined for delivery to the mobile communication device 122 and via use of the data packet latency settings 150-2, the queue classifier 440 stores the received data packet B7 in the queue Q1 for subsequent delivery to the mobile communication device 122.

In a similar manner, between time T2 and time T3, the queue classifier 440 stores each of the subsequently received data packets 196-1 (B) such as data packet B8, B9, etc., in the queue Q1.

As further shown, the scheduler 445 (associated with the communication management resource 140) manages transmissions of the received data packets in the queue Q1 over the antenna hardware 131-1 of the wireless base station 131 and the wireless communication link 127-2 for delivery to the mobile communication device 122. As previously discussed, the scheduler 445 ensures that each of the data packets B7, B8, B9, etc., stored in the queue Q1 are resident in the queue Q1 for no longer than, around, or less than a low latency value such as one millisecond or other suitable time value assigned to the low latency data packet setting L and corresponding queue Q1.

On average, the data packets B7, B8, B9, etc., stored in the queue Q1 are resident in the queue Q1 for around or less time than the data packets A6, A7, A8, etc., are stored in the queue Q2 based on the scheduler 445 providing lower latency forwarding of communications (data packets) in the queue Q1.

Thus, for certain time critical applications and/or communication devices, it may be desirable to store and forward data packets from the queue Q1 instead of the queue Q2.

FIG. 6 is an example diagram illustrating implementation of first data packet latency settings for a third time duration as discussed herein.

As previously discussed, between time T3 and time T4, the communication management resource 140 can be configured to implement or switch back to implementing the data packet latency settings 150-1 (as shown in FIG. 2A) in response to a trigger event such as the mobile communication device 121 needing lower latency L, expiration of a time duration, the mobile communication device 122 no longer requiring lower latency L, etc.

As previously discussed, the mobile communication device 121 can be configured to transmit a respective communication through the wireless base station 131 and network 190 to the server resource 195 for retrieval of content A. In response to receiving the request for content A, the server resource 195 transmits data packets 195-1 (stream of content such as labeled data packets Ax) over the network 190 through the wireless base station 131 to the mobile communication device 121.

In this example, the data packets 195-1 transmitted from the server resource 195 destined for delivery to the mobile communication device 121 include sequentially transmitted data packet such as data packet A11, data packet A12, data packet A13, etc.

The queue classifier 440 receives the data packet A11 destined for delivery to the mobile communication device 121. Based on a determination that the data packet A11 is destined for delivery to the mobile communication device 121 and via use of the data packet latency settings 150-1, the queue classifier 440 stores the received data packet A11 in the queue Q1 for subsequent delivery to the mobile communication device 121.

It is noted again that the queue Q1 supports a low latency L in which each of the data packets stored in the queue Q1 are forwarded from the queue Q1 around or in less time than a low latency threshold time value assigned to the low latency setting L. In other words, each data packet stored in the queue Q1 is resident in the queue Q1 for less than for no longer than the time value assigned to the low latency setting L.

In response to receiving the data packet A11, the queue classifier 440 determines from a destination value in the data packet A11 that the data packet A11 is directed for delivery to the mobile communication device 121. Based on mapping the identity of the mobile communication device 121 as specified by the received data packet A11 to the low latency setting L as indicated by the data packet latency settings 150-1, the queue classifier 440 stores the received data packet A11 in the queue Q1.

In response to receiving the data packet A12, the queue classifier 440 determines from a destination value in the data packet A12 or other suitable entity that the data packet A12 is directed to the mobile communication device 121. Based on mapping the identity of the mobile communication device 121 as specified by the received data packet A12 to the low latency setting L as indicated by the data packet latency settings 150-1, the queue classifier 440 stores the received data packet A12 in the queue Q1.

In a similar manner, between time T3 and time T4, the queue classifier 440 stores each of the received data packets 195-1 (A) such as data packets A11, A12, etc., in the queue Q1.

As further shown, the scheduler 445 (associated with the communication management resource 140) manages transmissions of the received data packets in the queue Q1 over the antenna hardware 131-1 of the wireless base station 131 and the wireless communication link 127-1 for delivery to the mobile communication device 121. As previously discussed, the scheduler 445 ensures that each of the data packets A11, A12, A13, etc., stored in the queue Q1 are resident in the queue Q1 for no longer than, around, or less than a low latency value such as one millisecond or other suitable time value assigned to the low latency data packet setting L and corresponding queue Q1.

Further, as previously discussed, the mobile communication device 122 can be configured to request retrieval of content B from the server resource 196. In such an instance, the mobile communication device 122 transmits a respective communication through the wireless base station 131 and network 190 to the server resource 196 for retrieval of content B. In response to receiving the request, the server resource 196 transmits data packets 196-1 (stream of content such as labeled data packets Bx) over the network 190 through the wireless base station 131 to the mobile communication device 122.

In this example, the data packets 196-1 transmitted from the server resource 196 destined for delivery to the mobile communication device 122 includes sequentially transmitted data packet such as data packet B11, data packet B12, data packet B13, etc. The queue classifier 440 receives the data packet B11 destined for delivery to the mobile communication device 122. Based on a determination that the data packet B11 is destined for delivery to the mobile communication device 122 and use of the corresponding data packet latency settings 150-1, the queue classifier 440 stores the received data packet B11 in the queue Q2 for subsequent delivery to the mobile communication device 122.

In response to receiving the data packet B12, the queue classifier 440 determines from a destination value in the data packet B12 that the data packet B12 is directed to the mobile communication device 122. Based on mapping the identity of the mobile communication device 122 as specified by the received data packet B12 to the high latency setting H as indicated by the data packet latency settings 150-1, the queue classifier 440 stores the received data packet B11 in the queue Q2.

In response to receiving the data packet B13, the queue classifier 440 determines from a destination value in the data packet B13 that the data packet B13 is directed to the mobile communication device 122. Based on mapping the identity of the mobile communication device 122 as specified by the received data packet B13 to the high latency setting H as indicated by the data packet latency settings 150-1, the queue classifier 440 stores the received data packet B13 in the queue Q2.

In a similar manner, between time T3 and time T4, the queue classifier 440 stores each of the received data packets 196-1 (B) in the queue Q2.

As further shown, the scheduler 445 manages transmissions of the received data packets in the queue Q2 over the antenna hardware 131-1 of the wireless base station 131 and the wireless communication link 127-2 for delivery to the mobile communication device 122. As previously discussed, the scheduler 445 ensures that each of the data packets B11, B12, B13, etc., stored in the queue Q2 are resident in the queue Q2 for less than a high latency value such as 50 milliseconds assigned to the high latency data packet setting H.

As previously discussed, on average, the data packets stored in the queue Q1 are resident in the queue Q1 for less time than the respective data packets are stored in the queue Q2 based on the scheduler 445 providing lower latency forwarding of communications (data packets) in the queue Q1. Thus, for certain time critical applications and/or communication devices, it may be desirable to store and forward data packets from the queue Q1 instead of the queue Q2, or vise-versa or vice versa.

It is further noted that one way a low latency indication (such as based on, for example, IETF RFCs 9330, 9331, & 9332-ECN protocol for LAS or so-called Low Latency, Low Loss, and Scalable Throughput) is used in communication networks is as follows:
1. The sending Application (e.g., on a user device or mobile communication device) indicates supports for ECN marking in the IP header of an IP packet (this packet includes the application payload).
2. The communication network (e.g., wireless station-3GPP base station or a Wi-Fi™ router, etc.) inspects the IP header and routes the data accordingly (e.g., if ECN field is set to ECT(1) indicating support for LAS will route these packets to a low latency queue or buffer).
3. If the communication network node (e.g., this can be the base station or a node in the route such as 5G core network nodes like the UPF to the receiving application on the mobile communication device that supports the above IETF RFCs) is congested it will change the IP header ECN field to CE (from ECT(1)).
4. The receiving application would receive this indication and send back a message to the sending application that congestion was experienced.
5. This would then allow the sending application to perform rate adaption (e.g., lower the data rate) to reduce the congestion in the route.

As previously discussed, this disclosure provides another mechanism (e.g., along with the above mechanism of ECN marking in the IP header by the sending application) to indicate a L, M, H latency tolerance/prioritization of data packets, potentially for exchange of some credit during conditions in which the user and corresponding mobile communication device are willing to accept higher latency of conveying data packets. This could imply that the nodes on the route can separate the packets in another level of low latency queues (e.g., a L queue, a M queue, & a H queue). The techniques as discussed herein can be implemented independently or in conjunction with the above latency management.

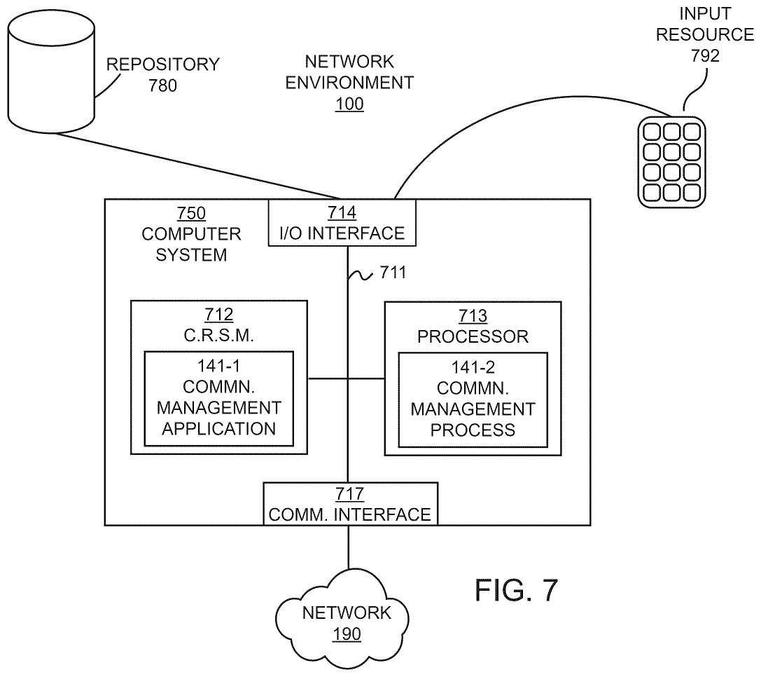

FIG. 7 is an example diagram illustrating example computer hardware and software operable to execute any of the operations as discussed herein.

Note that any of the resources (such as communication management resource 140, wireless base station 131, queue classifier 440, scheduler 445, communication device 121, communication device 122, etc.) as discussed herein can be configured to include computer processor hardware and/or corresponding executable instructions (such as associated with the communication management application 141-1) to carry out the different operations as discussed herein.

For example, as shown, computer system 750 of the present example includes interconnect 711 coupling computer readable storage media 712 such as a non-transitory type of media or computer readable storage hardware (which can be any suitable type of resource in which digital information can be stored and or retrieved), a processor 713 (computer processor hardware), I/O interface 714, and a communications interface 717.

I/O interface(s) 714 supports connectivity to repository 780 and input resource 792.

Computer readable storage medium 712 can be any hardware storage device such as memory, optical storage, hard drive, floppy disk, etc. In one example, the computer readable storage medium 712 stores instructions and/or data.

As shown, computer readable storage media 712 can be encoded with communication management application 141-1 in a respective one or more network nodes to carry out any of the operations as discussed herein.

During operation of one example, processor 713 accesses computer readable storage media 712 via the use of interconnect 711 in order to launch, run, execute, interpret or otherwise perform the instructions in communication management application 141-1 stored on computer readable storage medium 712. Execution of the communication management application 141-1 produces communication management process 141-2 to carry out any of the operations and/or processes as discussed herein.

Those skilled in the art will understand that the computer system 750 can include other processes and/or software and hardware components, such as an operating system that controls allocation and use of hardware resources to execute the management application 141-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 750 may reside at any location or can be included in any suitable resource in any network environment to implement functionality as discussed herein.

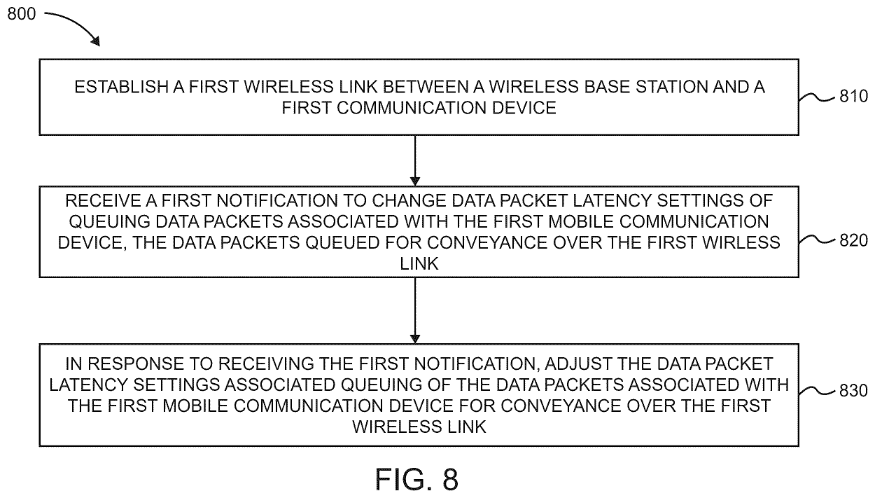

Functionality supported by the different resources will now be discussed via flowchart 800 in FIG. 8. Note that the steps in the flowcharts below can be executed in any suitable order.

FIG. 8 is a flowchart 800 illustrating an example method according to examples herein. Note that there will be some overlap with respect to concepts as discussed above. In processing operation 810, the communication management resource 140 establishes a first wireless link between a wireless base station and a first communication device.

In processing operation 820, the communication management resource 140 receives a first notification to change data packet latency settings of queuing data packets associated with the first mobile communication device, where the data packets are queued for conveyance over the first wireless link.

In processing operation 830, in response to receiving the first notification, the communication management resource adjusts the data packet latency settings associated queuing of the data packets associated with the first mobile communication device for conveyance over the first wireless link.

Note again that techniques herein are well suited to facilitate wireless connectivity in accordance with different available wireless services. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. A method comprising:
establishing a first wireless link between a wireless base station and a first mobile communication device in a network;
receiving a first notification to change data packet latency settings of queuing data packets destined for delivery from the wireless base station to the first mobile communication device over the first wireless link; and
in response to receiving the first notification, adjusting the data packet latency settings of queuing the data packets destined for delivery to the first mobile communication device over the first wireless link, the adjusted data packet latency settings supporting reduced energy consumption in the network.

2. The method as in claim 1, wherein adjusting the data packet latency settings includes:
prior to receiving the first notification, applying a first data packet latency setting to first data packets queued for delivery over the first wireless link to the first mobile communication device; and
subsequent to receiving the first notification, applying a second data packet latency setting to second data packets queued for delivery over the first wireless link to the first mobile communication device.

3. The method as in claim 2, wherein a magnitude of latency associated with the second data packet latency setting is greater than a magnitude of latency associated with the first data packet latency setting.

4. The method as in claim 3 further comprising:
subsequent to receiving the first notification, receiving a second notification to change the data packet latency settings of queuing data packets associated with the first mobile communication device; and
in response to receiving the second notification, applying the first data packet latency setting to third data packets queued for delivery over the first wireless link.

5. The method as in claim 1 further comprising:
communicating a message from the wireless base station over the first wireless link to the first mobile communication device, the message including a request to adjust the data packet latency settings of queuing data packets destined for delivery from the wireless base station to the first mobile communication device over the first wireless link.

6. The method as in claim 5 further comprising:
receiving the first notification from the first mobile communication device in response to the wireless base station communicating the message to the first mobile communication device.

7. The method as in claim 6, wherein the adjusted data packet latency settings are operative to reduce energy consumption by the first mobile communication device.

8. The method as in claim 6, wherein the wireless base station is operative to communicate the message to the first mobile communication device in response to detecting a need for implementation of lower data packet latency settings associated with a second mobile communication device in communication with the wireless base station over a second wireless link.

9. The method as in claim 1 further comprising:
receiving the first notification from the first mobile communication device; and
wherein the first notification indicates a time window in which to adjust the data packet latency settings of queuing data packets destined for delivery to the first mobile communication device, implementation of the adjusted data packet latency settings in the time window reducing power consumption by the first mobile communication device.

10. The method as in claim 1 further comprising:
establishing a second wireless link between the wireless base station and a second mobile communication device; and
in response to receiving a second notification indicating to change data packet latency settings associated with queuing of data packets for delivery over the second wireless link to the second mobile communication device, communicating a message from the wireless base station to the first mobile communication device, the message including an inquiry regarding adjustment of the data packet latency settings of queuing data packets destined for delivery to the first mobile communication device.

11. The method as in claim 1, wherein the first notification indicates a latency setting and timing information;
wherein adjusting the data packet latency settings includes: scheduling application of the adjusted data packet latency settings to data packets forwarded from the wireless base station over the wireless link to the first mobile communication device at a time as specified by the timing information.

12. The method as in claim 1, wherein the first notification is generated by the first mobile communication device based on power consumption associated with the first mobile communication device.

13. The method as in claim 1 further comprising:
tracking credit earned by the first mobile communication device accepting implementation of first data packet latency settings of queuing the data packets destined for delivery to the first mobile communication device;
wherein the adjusted data packet latency settings are second data packet latency settings; and
implementing the second data packet latency settings of queuing the data packets destined for delivery to the first mobile communication device in response to detecting that the tracked credit is greater than a threshold level.

14. A system comprising:
communication management hardware operative to:
establish a first wireless link between a wireless base station and a first mobile communication device in a network;
receive a first notification to change data packet latency settings of queuing data packets destined for delivery from the wireless base station over the first wireless link to the first mobile communication device; and
in response to receiving the first notification, adjust the data packet latency settings of queuing the data packets destined for delivery to the first mobile communication device over the first wireless link, the adjusted data packet latency settings supporting reduced energy consumption in the network.

15. The system as in claim 14, wherein the communication management hardware is further operative to:
prior to receiving the first notification, applying a first data packet latency setting to first data packets queued for delivery over the first wireless link to the first mobile communication device; and
subsequent to receiving the first notification, applying a second data packet latency setting to second data packets queued for delivery over the first wireless link to the first mobile communication device.

16. The system as in claim 14, wherein a magnitude of latency associated with the second data packet latency setting is greater than a magnitude of latency associated with the first data packet latency setting.

17. The system as in claim 16, wherein the communication management hardware is further operative to:
subsequent to receiving the first notification, receive a second notification to change the data packet latency settings of queuing data packets associated with the first mobile communication device; and
in response to receiving the second notification, apply the first data packet latency setting to third data packets queued for delivery over the first wireless link to the first mobile communication device.

18. The system as in claim 14, wherein the communication management hardware is further operative to:
communicate a message from the wireless base station over the first wireless link to the first mobile communication device, the message including a request to adjust the data packet latency settings of queuing data packets destined for delivery from the wireless base station over the first wireless link to the first mobile communication device.

19. The system as in claim 18, wherein the communication management hardware is further operative to:
receive the first notification from the first mobile communication device in response to the wireless base station communicating the message to the first mobile communication device.

20. The system as in claim 19, wherein the adjusted data packet latency settings are operative to reduce energy consumption by the first mobile communication device.

21. The system as in claim 19, wherein the wireless base station is operative to communicate the message to the first mobile communication device in response to detecting a need for implementation of lower data packet latency settings associated with a second mobile communication device in communication with the wireless base station over a second wireless link.

22. The system as in claim 14, wherein the communication management hardware is further operative to:
receive the first notification from the first mobile communication device; and
wherein the first notification indicates a time window in which to adjust the data packet latency settings of queuing subsequent data packets destined for delivery to the first mobile communication device, implementation of the adjusted data packet latency settings in the time window reducing power consumption by the first mobile communication device.

23. The system as in claim 14, wherein the communication management hardware is further operative to:
establish a second wireless link between the wireless base station and a second mobile communication device; and
in response to receiving a second notification indicating to change data packet latency settings associated with queuing of data packets for delivery over the second wireless link to the second mobile communication device, communicate a message from the wireless base station to the first mobile communication device, the message including an inquiry regarding adjustment of the data packet latency settings of queuing data packets destined for delivery to the first mobile communication device.

24. The system as in claim 14, wherein the first notification indicates a latency setting and timing information; and
wherein the communication management hardware is further operative to: schedule application of the adjusted data packet latency settings to data packets subsequently forwarded from the wireless base station over the wireless link to the first mobile communication device at a time as specified by the timing information.

25. The system as in claim 14, wherein the first notification is generated by the first mobile communication device based on power consumption associated with the first mobile communication device.

26. The system as in claim 14, wherein the communication management hardware is further operative to:
track credit earned by the first mobile communication device accepting implementation of first data packet latency settings of queuing the data packets destined for delivery to the first mobile communication device;
wherein the adjusted data packet latency settings are second data packet latency settings; and
implement the second data packet latency settings of queuing the data packets destined for delivery to the first mobile communication device in response to detecting that the tracked credit is greater than a threshold level.

27. Computer-readable storage hardware having instructions stored thereon, the instructions, when carried out by computer processor hardware, cause the computer processor hardware to:
establish a first wireless link between a wireless base station and a first mobile communication device in a network;
receive a first notification to change data packet latency settings of queuing data packets destined for delivery from the wireless base station to the first mobile communication device over the first wireless link; and
in response to receiving the first notification, adjust the data packet latency settings of queuing the data packets destined for delivery to the first mobile communication device over the first wireless link, the adjusted data packet latency settings supporting reduced energy consumption in the network.
